(19) United States
(12) Patent Application Publication
(10) Pub. No.: US 2023/0264399 A1
(43) Pub. Date: Aug. 24, 2023

(54) TOGGLE LINK CLAMPING MECHANISM WITH NEGATIVE REAR ANGLE

(71) Applicant: NINGBO ZHAFIR PLASTICS MACHINERY MANUFACTURING VO., LTD., Ningbo (CN)

(72) Inventors: Nanhong FU, Ningbo (CN); Xianda LI, Ningbo (CN); Bangfeng CHEN, Ningbo (CN); Tianpeng HE, Ningbo (CN)

(21) Appl. No.: 18/004,851

(22) PCT Filed: Apr. 13, 2021
(86) PCT No.: PCT/CN2021/087000

§ 371 Date: Jan. 9, 2023

(30) Foreign Application Priority Data
Aug. 13, 2020 (CN) 202010810791.X

(51) Int. Cl. B29C 45/66

(52) U.S. Cl. CPC B29C 45/661

(57) ABSTRACT

A toggle link clamping mechanism with a negative rear angle comprises a tail plate, a movable mold plate, and a toggle link mechanism. The toggle link mechanism comprises a thrust seat and a pair of link assemblies symmetrically distributed with one above the other. Each link assembly is composed of two independent front links, three independent rear links, and a small link, wherein front ends of the two front links are hinged to a rear face of the movable mold plate, rear ends of the two front links are hinged to front ends of the three rear links, rear ends of the three rear links are hinged to a front face of the tail plate, one end of the small link penetrates through a middle portion of the rear link in the middle and is hinged to the middle portion of the rear link in the middle.

### TECHNICAL FIELD

The invention relates to a clamping mechanism for injection molding machines, in particular to a toggle link clamping mechanism with a negative rear angle.

### DESCRIPTION OF RELATED ART

In recent years, competition in the industry of injection molding machines has become increasingly competitive, which prompts manufacturers to continuously improve the working performance of injection molding machines through technical innovations. The force amplification efficiency and speed increase capacity of existing toggle link clamping mechanisms for injection molding machines have been close to limits and cannot be further improved anymore, and thus, these toggle link clamping mechanisms can hardly meet market requirements.

For example, Chinese invention patent (Patent No. ZL 200910101481.4) discloses a toggle link clamping mechanism, which comprises a tail plate, a movable mold plate and a pair of toggle link structures; each toggle link structure comprises a front link, a rear link, a small link and a thrust seat, wherein a front end of the front link is hinged to a rear face of the movable mold plate, a rear end of the front link is hinged to a front end of the rear link, a rear end of the rear link is hinged to a front face of the tail plate, one end of the small link is hinged to the middle of the rear link, the other end of the small link is hinged to one side of the thrust seat, and the thrust seat is located between the tail plate and the movable mold plate and is able to move back and forth; the toggle link clamping mechanism is characterized in that the front link is an integral part, the front end of the front link is provided with two front lugs hinged to the rear face of the movable mold plate, and the rear end of the front link is provided with three rear lugs hinged to the rear link. The toggle link clamping mechanism has the advantages that the movable mold plate and the tail plate are simple in structure and the service life is long. However, due to the fact that the hinge joint of one end of the small link and the rear link and the hinge joint of the other end of the small link and one side of the thrust seat are located on a same side of a boundary which is the center connecting line of the front end and the rear end of the rear link (see FIG. 1 in Document 200910101481.4), the toggle link clamping mechanism has a long stroke and a small force amplification ratio.

### BRIEF SUMMARY OF THE INVENTION

The technical issue to be settled by the invention is to provide a toggle link clamping mechanism with a negative rear angle, which has a short stroke and a large force amplification ratio.

The technical solution adopted by the invention to settle the above technical issue is as follows:

a toggle link clamping mechanism with a negative rear angle comprises a tail plate, a movable mold plate, and a toggle link mechanism disposed between the tail plate and the movable mold plate and used for driving the movable mold plate to move with respect to the tail plate, the toggle link mechanism comprising a thrust seat and a pair of link assemblies which are symmetrically distributed with one above the other, wherein each link assembly is composed of two front links which are independent of each other and are parallelly arranged at a same height, three rear links which are independent of each other and are parallelly arranged at a same height, and a small link, front ends of the two front links are hinged to a rear face of the movable mold plate, rear ends of the two front links are hinged to front ends of the three rear links, rear ends of the three rear links are hinged to a front face of the tail plate, one end of the small link penetrates through a middle portion of the rear link in the middle and is hinged to the middle portion of the rear link in the middle, the other end of the small link is hinged to the thrust seat, and with a center connecting line of the front end and the rear end of the rear link as a boundary, a hinge joint of the middle portion of the rear link in the middle and one end of the small link is located on one side of the center connecting line, a hinge joint of the other end of the small link and the thrust seat is located on other side of the center connecting line.

Three rear brackets are disposed on the rear face of the movable mold plate, a front big hinge pin is fixed to rear ends of the three brackets, the front big hinge pin is unable to rotate with respect to the three rear brackets, the front ends of the two front links are movably disposed around the front big hinge pin and are able to rotate with respect to the front big hinge pin, and the front end of each front link is located between the rear ends of two adjacent rear brackets and is attached to side faces of the two adjacent rear brackets; a middle big hinge pin is fixed to the front ends of the three rear links, the middle big hinge pin is unable to rotate with respect to the three rear links, the rear ends of the two front links are movably disposed around the middle big hinge pin and are able to rotate with respect to the middle big hinge pin, and the rear end of each front link is located between the front ends of two adjacent rear links and is attached to side faces of the two adjacent rear links; two front brackets are disposed on the front face of the tail plate, a rear big hinge pin is fixed to the rear ends of the three rear links, the rear big hinge pin is unable to rotate with respect to the three rear links, front ends of the two front brackets are disposed around the rear big hinge pin and are able to rotate with respect to the rear big hinge pin, and the front end of each front bracket is located between the rear ends of two adjacent rear links and is attached to side faces of the two adjacent rear links; a square through hole is formed in the middle portion of the rear link in the middle in a direction from the front end to the rear end, and one end of the small link penetrates through the square through hole; a first small hinge pin is fixed on two sides in a width direction of the square through hole in the middle portion of the rear link in the middle, the first small hinge pin is unable to rotate with respect to the two sides in the width direction of the square through hole in the middle portion of the rear link in the middle, one end of the small link is movably disposed around the first small hinge pin and is able to rotate with respect to the first small hinge pin, and the two sides in the width direction of the square through hole in the middle portion of the rear link in the middle are attached to two side faces of one end of the small link; an end of the thrust seat for hinging to the other end of the small link is divided into two portions, such that the other end of the small link is exactly inlaid in the thrust seat; a second small hinge pin is fixed to the two portions of the end of the thrust seat, the second small hinge pin is unable to rotate with respect to the two portions of the end of the thrust seat, and the other end of the small link is movably disposed around the second small hinge pin, is able to rotate with respect to the small hinge pin, and the other end of the small link is clamped between the two portions of the end of the thrust seat.

The rear link in the middle is a three-hole link, the two rear links symmetrically distributed on two sides of the three-hole link are two-hole links, the front end and the rear end of the two-hole rear links and the three-hole rear link are each provided with an end hole, a shaft hole is formed in each of the two sides in the width direction of the square through hole in the middle portion of the three-hole rear link, the two coaxial shaft holes form a middle hole of the three-hole rear link, the middle hole is located on one side of a center connecting line of the two end holes, the end hole at the front end is matched with the middle large hinge pin, the end hole at the rear end is matched with the rear big hinge pin, and the middle hole is matched with the first small hinge pin. The middle hole is a hinge joint of the middle portion of the three-hole rear link and one end of the small link and is located on one side of the center connecting line of the two end holes, and a hinge joint of the other end of the small link and the thrust seat is located on the other side of the center connecting line of the two end holes.

Compared with the prior art, the invention has the following advantages:

According to the toggle link clamping mechanism provided by the invention, with the center connecting line of the front end and the rear end of the rear links as a boundary, the hinge joint of the middle portion of the rear link in the middle and one end of the small link is located on one side of the center connecting line, the hinge joint of the other end of the small link and the thrust seat is located on other side of the center connecting line, that is, the two hinge joints of the small link are not located on the same side of the rear link, such that the stroke of the toggle link clamping mechanism is shortened, and the force amplification efficiency is improved, thus improving the production efficiency and reducing the production cost.

### BRIEF DESCRIPTION OF THE SEVERAL VIEWS OF THE DRAWINGS

FIG. 1 is a top view of a toggle link clamping mechanism with a negative rear angle according to the invention;

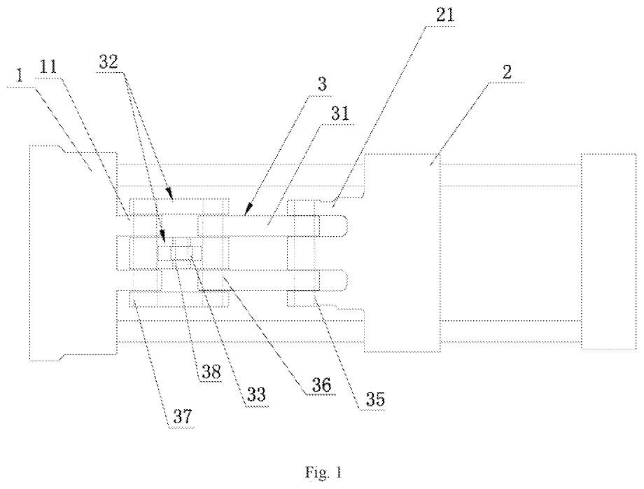

FIG. 2 is a sectional view of a movable mold plate of the toggle link clamping mechanism with a negative rear angle before and after moving with respect to a tail plate according to the invention;

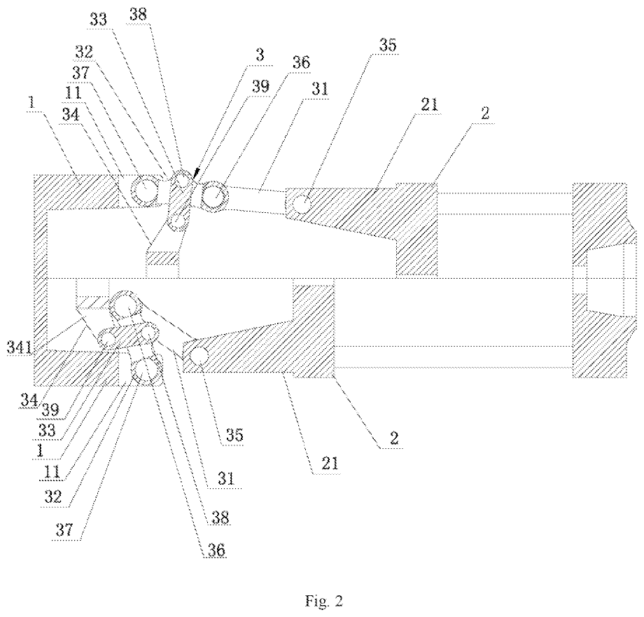

FIG. 3 is a structural diagram of a three-hole rear link of a link assembly of the toggle link clamping mechanism with a negative rear angle according to the invention.

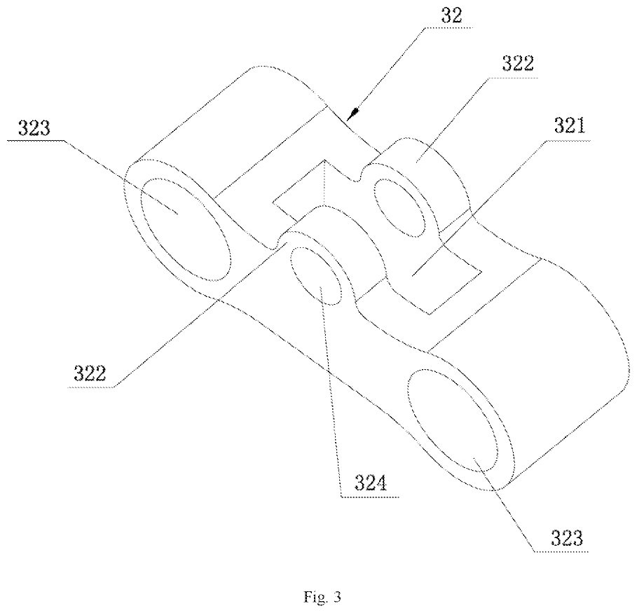

### DETAILED DESCRIPTION OF THE INVENTION

The invention will be described in further detail below in conjunction with the accompanying drawings and embodiments.

The invention provides a toggle link clamping mechanism with a negative rear angle, which, as shown, comprises a tail plate 1, a movable mold plate 2, and a toggle link mechanism 3 disposed between the tail plate 1 and the movable mold plate 2 and used for driving the movable mold plate 2 to move with respect to the tail plate 1, wherein the toggle link mechanism 3 comprises a thrust seat 34 (crosshead) and a pair of link assemblies symmetrically distributed with one above the other; each link assembly is composed of two front links 31 which are independent of each other and are parallelly arranged at a same height, three rear links 32 which are independent of each other and are parallelly arranged at a same height, and a small link 33; front ends of the two front links 31 are hinged to a rear face of the movable mold plate 2, rear ends of the two front links 31 are hinged to front ends of the three rear links 32, rear ends of the three rear links 32 are hinged to a front face of the tail plate 1, one end of the small link 33 penetrates through a middle portion of the rear link 32 in the middle and is hinged to the middle portion of the rear link 32 in the middle, the other end of the small link 33 is hinged to the thrust seat 34, and with a center connecting line of the front end and the rear end of the rear link 32 as a boundary, a hinge joint of the middle portion of the rear link 32 in the middle and the one end of the small link 33 is located on one side of the connecting line, a hinge joint of the other end of the small link 33 and the thrust seat 34 is located on other side of the connecting line.

In this embodiment, three rear brackets 21 are disposed on the rear face of the movable mold plate 2, a front big hinge pin 35 is fixed to rear ends of the three brackets 21, the front big hinge pin 35 is unable to rotate with respect to the three rear brackets 21, the front ends of the two front links 31 are movably disposed around the front big hinge pin 35 and are able to rotate with respect to the front big hinge pin 35, and the front end of each front link 31 is located between the rear ends of two adjacent rear brackets 21 and is attached to side faces of the two adjacent rear brackets 21; a middle big hinge pin 36 is fixed to the front ends of the three rear links 32, the middle big hinge pin 36 is unable to rotate with respect to the three rear links 32, the rear ends of the two front links 31 are movably disposed around the middle big hinge pin 36 and are able to rotate with respect to the middle big hinge pin 36, and the rear end of each front link 31 is located between the front ends of two adjacent rear links 32 and is attached to side faces of the two adjacent rear links 32; two front brackets 11 are disposed on the front face of the tail plate 1, a rear big hinge pin 37 is fixed to the rear ends of the three rear links 32, the rear big hinge pin 37 is unable to rotate with respect to the three rear links 32, front ends of the two front brackets 11 are disposed around the rear big hinge pin 37 and are able to rotate with respect to the rear big hinge pin 37, and the front end of each front bracket 11 is located between the rear ends of two adjacent rear links 32 and is attached to side faces of the two adjacent rear links 32; a square through hole 321 is formed in the middle portion of the rear link 32 in the middle in a direction from the front end to the rear end, and one end of the small link 33 penetrates through the square through hole 321; a first small hinge pin 38 is fixed on two sides in a width direction of the square through hole 321 in the middle portion of the rear link 32 in the middle, the first small hinge pin 38 is unable to rotate with respect to the two sides in the width direction of the square through hole 321 in the middle portion of the rear link 32 in the middle, one end of the small link 33 is movably disposed around the first small hinge pin 38 and is able to rotate with respect to the first small hinge pin 38, and the two sides 332 in the width direction of the square through hole 321 in the middle portion of the rear link 32 in the middle are attached to two side faces of the one end of the small link 33; an end of the thrust seat for hinging to the other end of the small link is divided into two portions, such that the other end of the small link 33 is exactly inlaid in the thrust seat 34; a second small hinge pin 39 is fixed to the two portions of the end of the thrust seat 34, the second small hinge pin 39 is unable to rotate with respect to the two portions of the end of the thrust seat 34, and the other end of the small link 33 is movably disposed around the second small hinge pin 39, is able to rotate with respect to the small hinge pin 39, and the other end of the small link 33 is clamped between the two portions 341 of the end of the thrust seat 34.

In this embodiment, the rear link 32 in the middle is a three-hole link, the two rear links 32 symmetrically distributed on two sides of the three-hole link are two-hole links, the front end and the rear end of the two-hole rear links and the three-hole rear link are each provided with an end hole 323, a shaft hole 324 is formed in each of the two sides 322 in the width direction of the square through hole 321 in the middle portion of the three-hole rear link, the two coaxial shaft holes 324 form a middle hole of the three-hole rear link, the middle hole is located on one side of a center connecting line of the two end holes 323, the end hole 323 at the front end is matched with the middle large hinge pin 36, the end hole 323 at the rear end is matched with the rear big hinge pin 37, and the middle hole is matched with the first small hinge pin 38. The middle hole is a hinge joint of the middle portion of the three-hole rear link and one end of the small link 33 and is located on one side of the center connecting line of the two end holes 323, and a hinge joint of the other end of the small link 33 and the thrust seat 34 is located on the other side of the center connecting line of the two end holes 323.

What is claimed is:

1. A toggle link clamping mechanism with a negative rear angle, comprising a tail plate, a movable mold plate, and a toggle link mechanism disposed between the tail plate and the movable mold plate and used for driving the movable mold plate to move with respect to the tail plate, the toggle link mechanism comprising a thrust seat and a pair of link assemblies which are symmetrically distributed with one above the other, wherein each link assembly is composed of two front links which are independent of each other and are parallelly arranged at a same height, three rear links which are independent of each other and are parallelly arranged at a same height, and a small link; front ends of the two front links are hinged to a rear face of the movable mold plate, rear ends of the two front links are hinged to front ends of the three rear links, rear ends of the three rear links are hinged to a front face of the tail plate, one end of the small link penetrates through a middle portion of rear link in the middle and is hinged to the middle portion of the rear link in the middle, other end of the small link is hinged to the thrust seat, and with a center connecting line of the front end and the rear end of the rear link as a boundary, a hinge joint of the middle portion of the rear link in the middle and the one end of the small link is located on one side of the center connecting line, a hinge joint of the other end of the small link and the thrust seat is located on other side of the center connecting line.

2. The toggle link clamping mechanism with a negative rear angle according to claim 1, wherein three rear brackets are disposed on the rear face of the movable mold plate, a front big hinge pin is fixed to rear ends of the three brackets, the front big hinge pin is unable to rotate with respect to the three rear brackets, the front ends of the two front links are movably disposed around the front big hinge pin and are able to rotate with respect to the front big hinge pin, and the front end of each front link is located between the rear ends of two adjacent rear brackets and is attached to side faces of the two adjacent rear brackets; a middle big hinge pin is fixed to the front ends of the three rear links, the middle big hinge pin is unable to rotate with respect to the three rear links, the rear ends of the two front links are movably disposed around the middle big hinge pin and are able to rotate with respect to the middle big hinge pin, and the rear end of each front link is located between the front ends of two adjacent rear links and is attached to side faces of the two adjacent rear links; two front brackets are disposed on the front face of the tail plate, a rear big hinge pin is fixed to the rear ends of the three rear links, the rear big hinge pin is unable to rotate with respect to the three rear links, front ends of the two front brackets are disposed around the rear big hinge pin and are able to rotate with respect to the rear big hinge pin, and the front end of each front bracket is located between the rear ends of two adjacent rear links and is attached to side faces of the two adjacent rear links; a square through hole is formed in the middle portion of the rear link in the middle in a direction from the front end to the rear end, and one end of the small link penetrates through the square through hole; a first small hinge pin is fixed on two sides in a width direction of the square through hole in the middle portion of the rear link in the middle, the first small hinge pin is unable to rotate with respect to the two sides in the width direction of the square through hole in the middle portion of the rear link in the middle, one end of the small link is movably disposed around the first small hinge pin and is able to rotate with respect to the first small hinge pin, and the two sides in the width direction of the square through hole in the middle portion of the rear link in the middle are attached to two side faces of the one end of the small link; an end of the thrust seat for hinging to the other end of the small link is divided into two portions, such that the other end of the small link is exactly inlaid in the thrust seat; a second small hinge pin is fixed to the two portions of the end of the thrust seat, the second small hinge pin is unable to rotate with respect to the two portions of the end of the thrust seat, and the other end of the small link is movably disposed around the second small hinge pin, is able to rotate with respect to the small hinge pin, and the other end of the small link is clamped between the two portions of the end of the thrust seat.

3. The toggle link clamping mechanism with a negative rear angle according to claim 2, wherein the rear link in the middle is a three-hole link, the two rear links symmetrically distributed on two sides of the three-hole link are two-hole links, the front end and the rear end of the two-hole rear links and the three-hole rear link are each provided with an end hole, a shaft hole is formed in each of the two sides in the width direction of the square through hole in the middle portion of the three-hole rear link, the two coaxial shaft holes form a middle hole of the three-hole rear link, the middle hole is located on one side of a center connecting line of the two end holes, the end hole at the front end is matched with the middle large hinge pin, the end hole at the rear end is matched with the rear big hinge pin, and the middle hole is matched with the first small hinge pin.
